(19) United States
(12) Patent Application Publication
(10) Pub. No.: US 2005/0069713 A1
(43) Pub. Date: Mar. 31, 2005

(54) Capillary coating method

(76) Inventors: Rahul Gupta, Santa Clara, CA (US); Joseph Carr, Los Gatos, CA (US)

Correspondence Address: Siemens Corporation;Intellectual Property Department, 170 Wood Avenue South, Iselin, NJ, 08830, US

(21) Appl. No.: 10/674,864

(22) Filed: Sep. 30, 2003

(51) Int. Cl. B05D 5/06

(52) U.S. Cl. 428/411.1; 427/402; 427/430.1; 427/66

(57) ABSTRACT

Material is deposited on a substrate layer by forming a multilayered structure and dipping the multilayered structure into a solution containing the material for a sufficient length of time to allow the solution to spread through capillary action to a predetermined region. The multilayered structure is formed by coating the substrate layer with a spacer/pattern layer that defines the predetermined region and pressing a cover layer against the space/pattern layer.

### BACKGROUND OF THE INVENTION

1. Field of the Invention

The present invention relates to the deposition of materials on substrates. More particularly, the present invention relates to making use of capillary action to coat substrates.

2. Description of Related Art

Electronic devices such as information displays, large area sensors, planar light sources, solar cells and circuitry composed of organic semiconducting materials require the precise placement of materials between and around conducting electrodes, usually composed of metals. The films deposited on the substrate range in thickness from several nanometers to tens of micrometers. A common requirement is the deposited materials must be uniform in thickness across the substrate. Another requirement is the need for precise spatial deposition of the materials. Such devices typically include a pair of electrodes (e.g., an anode and a cathode) with at least one semiconductive layer between the electrodes. Optionally, insulating layers may be required in the stack structure. There are several methods currently employed to produce the deposition and patterning of said materials onto the substrate, including: spin coating, ink jet printing, flexographic printing and screen printing.

Spin coating is performed by depositing a relatively large quantity of the material onto the substrate, then spinning the substrate to form a uniform film of constant thickness. The remaining film has a volume of only 1-5% of the original volume dispensed, depending on the nature of the material solution and spin conditions. Spin coating is not selective, but covers the entire substrate with the material. To achieve precise, selective patterns, subsequent steps must be performed to remove the unwanted material. Methods to remove the unwanted material include: masking and etching, lift-off processes and including photo-activated moieties in the materials. The latter are exposed to electromagnetic energy, usually UV light, to partially crosslink the material where wanted. The unwanted materials are subsequently washed away with a suitable solvent.

Another conventional type of material deposition is ink jet printing. The printer forms patterns on a medium or substrate, by expelling droplets of ink, often comprising organic material, in a controlled fashion so that the droplets land on the medium in a pattern. Such a printer can be conceptualized as a mechanism for moving and placing the medium in a position such that ink droplets can be placed on the medium, a printing cartridge which controls the flow of ink and expels droplets of ink to the medium, and appropriate control hardware and software. A conventional print cartridge for an inkjet type printer comprises an ink containment device and a fingernail-sized apparatus, commonly known as a print head, which heats and expels ink droplets in a controlled fashion. The print cartridge may contain a storage vessel for ink, or the storage vessel may be separate from the print head. Other conventional inkjet type printers use piezo elements that can vary the ink chamber volume through use of the piezo-electric effect to expel ink droplets in a controlled fashion.

A disadvantage of inkjet printing is that it is limited in speed. Some inkjet printers use multiple print cartridges or arrays of nozzles, allowing a plurality of droplets to be emitted simultaneously. However, to maintain the capability of high-resolution printing, mechanical or electronic adjustment is then necessary so that droplets printed by one nozzle alight at precise locations on the receiving substrate relative to those printed by another nozzle. Such adjustments require additional expense and often slow down the printing process. Even if the printing process is not appreciably slowed down, the multiple print cartridges or arrays of nozzles may not provide enough additional speed to the printing process.

Other methods to apply material onto a substrate exist such as flexographic printing, wherein a roller, such as an anilox roller, is used to apply the desired pattern of material onto the substrate. Another method to deposit material on a substrate is screen printing, wherein a roller is rolled over a screen that determines the pattern to be printed. Both these methods have the disadvantages of having limited spatial resolution and, since the processes involve the mechanism of application touching the surface of the substrate, there is increased likelihood of contamination.

For the foregoing reasons, there exists a need for a method and apparatus for applying material to a substrate that allows for the application of high spatial resolution patterns at high speed.

### SUMMARY OF THE INVENTION

It is therefore an object of the present invention to provide a method of depositing material on a substrate using capillary forces to draw the material substantially parallel to the surface of the substrate.

It is another object of the present invention to provide a method of depositing material on a substrate, using capillary forces, that allows quicker deposition than using an inkjet method.

It is another object of the present invention to provide a method of depositing material on a substrate, using capillary forces, that results in spatial resolution that is greater than if a flexographic printing method were used.

It is another object of the present invention to provide a method of depositing material on a substrate, using capillary forces, that results in spatial resolution that is greater than if a screen printing method were used.

It is another object of the present invention to provide a method of depositing a plurality of materials onto a substrate using capillary forces to draw the materials onto the surface of the substrate sequentially.

A spacer/pattern layer is coated onto the substrate upon which a film of material is desired. A cover layer is then placed in contact with the spacer/pattern layer. Pressure is applied and the spacer/pattern layer is held between the substrate and the cover layer, forming a multilayered structure. At least one edge of the multilayered structure is dipped into a solution containing the desired material for deposition. Advantageously, the capillary action draws solution into the multilayered structure. The solution is allowed to dry and a patterned film remains once the cover layer is removed. If desired, the process may be repeated with different solutions. Advantageously, different edges of the multilayered structure and/or multilayered structures having the same substrate but different spacer/pattern layers may be used to facilitate subsequent deposition of additional solutions.

### BRIEF DESCRIPTION OF THE DRAWINGS

FIG. 1(a) shows the top view of an embodiment of a patterned substrate according to the present invention.

FIG. 1(b) shows the side view of an embodiment of a patterned substrate according to the present invention.

FIG. 1(c) shows the side view of an embodiment of a patterned substrate in contact with a cover plate according to the present invention.

FIG. 2(a) shows an embodiment of the dipping process of a multilayered structure according to the present invention.

FIG. 2(b) shows an embodiment of the multilayered structure after the dipping process according to the present invention.

FIG. 2(c) shows an embodiment of the multilayered structure after the cover plate has been removed from it according to the present invention.

FIG. 2(d) shows an embodiment of the multilayered structure after the cover plate has been removed from it and the solution which was drawn into the multilayered structure has dried into a film, according to the present invention.

FIG. 3(a) shows an embodiment of the first dipping process of a second multilayered structure according to the present invention.

FIG. 3(b) shows an embodiment of the second multilayered structure after the first dipping process according to the present invention.

FIG. 3(c) shows an embodiment of the second multilayered structure after the first dipping process and the cover plate has been removed from it according to the present invention.

FIG. 3(d) shows an embodiment of the second multilayered structure after the first dipping process, the cover plate has been removed from it, and the first solution which was drawn into the multilayered structure has dried into a film, according to the present invention.

FIG. 3(e) shows an embodiment of the second dipping process of a second multilayered structure according to the present invention.

FIG. 3(f) shows an embodiment of the second multilayered structure after the second dipping process according to the present invention.

FIG. 3(g) shows an embodiment of the second multilayered structure after the second dipping process and the cover plate has been removed from it according to the present invention.

FIG. 3(h) shows an embodiment of the second multilayered structure after the second dipping process, the cover plate has been removed from it, and the second solution which was drawn into the multilayered structure has dried into a film, according to the present invention.

FIG. 4 shows an embodiment of an OLED, a portion of which is manufactured according to the present invention.

### DETAILED DESCRIPTION

FIG. 1 shows the top view of an embodiment of a patterned substrate, comprising substrate layer 10 coated with spacer/pattern layer 20. Some types of material that may be used for substrate layer 10, by way of example only, are glass substrates, plastic substrates (such as polyethylene terephthalate, polyethylene naphthalate, polymide, polycarbonate), metal foils, ceramic substrates, laminated glass, and thin flexible glass. Some applications for substrates, by way of example only, are substrates for organic thin film transistors (TFTs), hybrid organic/inorganic TFTs, alpha-numeric or passive-matrix or active-matrix OLEDs or combined TFT/OLED devices. Spacer/pattern layer 20, in a preferred embodiment, is made of photoresist, though in other preferred embodiments other materials may be used, depending on factors such as the composition of the substrate layer, by way of example only. In a preferred embodiment, spacer/pattern layer 20 is formed by selectively removing portions of the spacer/pattern material where a coating film is desired. The desired pattern provides at least one open channel along at least one edge of patterned spacer/pattern layer 20. FIG. 1 (b) shows a side view of the patterned substrate.

With reference to FIG. 1(c), a cover plate 30 is brought into contact with spacer/pattern layer 20 to form multilayered structure 100. In a preferred embodiment, cover plate 30 is made of similar materials as those used for the substrate, preferably something rigid like glass. The surface of cover plate 30 may need to be treated such that the material does not stick to it when it is removed. This can be done by using surfactants, plasma treatments, etc. Common surface treatments include polytetraflouroethylene (PTFE), methylsilicates, silicones. These treatments may be applied as solutions, vapors or as films applied ex-situ. The surface treatment is specific to the material being deposited and has a composition such that the deposited material and the surface treatment are mutually immiscible. Alternatively, the surface may be composed of a composite of a rigid support adhered to a free-standing film of plate of material having the desired physical properties toward the deposited material, e.g., non-wetting. The thickness of spacer/pattern layer 20 depends on the thickness of the film needed and the concentration of the solution that will be applied. Since the rate at which the solution will be drawn in will depend on the solutions surface tension and viscosity, spacer/pattern layer 20 can be thin for highly concentrated solutions and for materials that are not dissolved in a solvent but are liquids by themselves and that can be solidified by post treatment such as UV exposure or thermal curing. In a preferred embodiment, spacer/pattern layer 20 is between 1 and 100 microns thick. Different patterns may be defined by spacer/pattern layer 20, such as, by way of example only, lines, circles, arcs, polygonal shapes, logos, and/or a combination thereof.

In an alternative preferred embodiment, cover plate 30 already has a portion of spacer/pattern layer 20 before multilayered structure 100 is formed. In this embodiment, the other portion of spacer/pattern layer 20 is a coating on substrate layer 10, and the two portions of spacer/pattern layer 20 are pressed together to form a complete spacer/pattern layer 20.

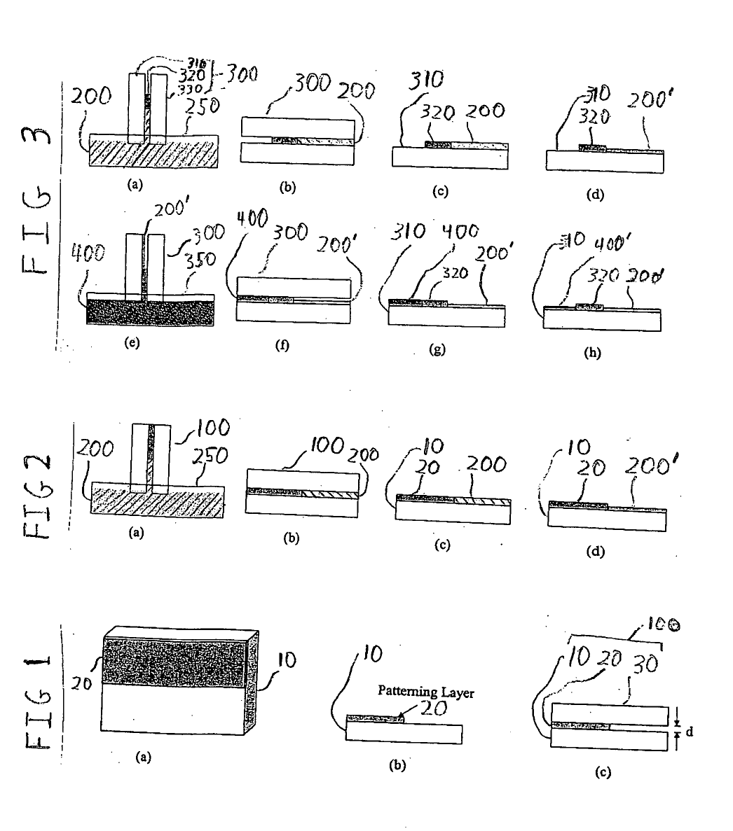

With reference to FIG. 2(a), an embodiment of the dipping process according to the present invention is shown. Multilayered structure 100 is dipped, or at least partially immersed, into solution 200 which is contained in container 250. By way of example only, solution 200 may comprise Baytron CH8000 (PEDOT:PSS with additives as made by HC Starck) in deioinized water, or light emitting polymer in xylene (or other solvents like mesitylene or cosolvent systems). Solution 200 could have different solvents and have different concentrations. There can be multiple components in solutions in order to control the uniformity of drying (or physical properties such as conductivity of PEDOT) such as cosolvents/additives like glycols and N-methyl pyrolidone in polar (water based) solutions, by way of example only), At least one open channel situated along the edge of multilayered structure 100 provides path(s) by which solution 200 permeates multilayered structure 100 substantially due to capillary action. Multilayered structure 100 is dipped long enough to fill the part of multilayered structure 100 that needs to be filled. Although a simple dipping and capillary action is sufficient to accomplish this in a preferred embodiment, in alternative preferred embodiments vacuum and/or pressure is used to force the solution to travel farther and faster. Such techniques may be necessary to employ where multilayered structure 100 has such a large surface area that capillary action alone is not sufficient to properly distribute solution 200.

Multilayered structure 100 is removed from the portion of solution 200 that remains in container 250 and then, in a preferred embodiment, laid flat, as shown in FIG. 2(b). Cover plate 30 is removed from multilayered structure 100, leaving behind—as shown in FIG. 2(c)—substrate layer 10 coated with patterned spacer/pattern layer 20 and the portion of solution 200 that has permeated. With reference to FIG. 2(d), the permeating solution 200 dries into a coating material film 200′. The thickness of the film may be predetermined by the thickness of spacer/pattern layer 20 and/or the concentration of solids in solution 200.

As described above, the pattern of coating material film 200′ depends on the pattern in spacer/pattern layer 20, which inhibits flow beyond a predetermined region. Spacer/pattern layer 20 may have a plurality of such predetermined regions, and each region may be used to contain a different solution, as described below.

With reference to FIG. 3(a), an embodiment of the first dipping process for multilayered structure 300 according to the present invention is shown. Multilayered structure 300 comprises substrate layer 310, patterned spacer/pattern layer 320, and cover layer 330. Multilayered structure 300 is dipped, or at least partially immersed, into solution 200, which is contained in container 250. At least one open channel situated along at least a first edge of multilayered structure 300 provides path(s) by which solution 200 permeates multilayered structure 300 substantially due to capillary action.

Multilayered structure 300 is removed from the portion of solution 200 that remains in container 250 and then, in a preferred embodiment, laid flat, as shown in FIG. 3(b). Cover plate 330 is removed from multilayered structure 300, leaving behind—as shown in FIG. 3(c)—substrate layer 310 coated with patterned spacer/pattern layer 320 and the portion of solution 200 that has permeated. With reference to FIG. 3(d), the permeating solution 200 dries into a coating material film 200′.

Next, with reference to FIG. 3(e), in a preferred embodiment multilayered structure 300 is re-formed by again bringing cover plate 330 into contact with spacer/pattern layer 320. In an alternative preferred embodiment, the first cover plate 330 is discarded and another one is used in its place to re-form multilayered structure 300. Multilayered structure 300 is dipped, or at least partially immersed, into solution 400, which is contained in container 350. At least one open channel situated along an edge, which in a preferred embodiment is different from the first edge, of multilayered structure 300 provides path(s) by which solution 400 permeates multilayered structure 300 substantially due to capillary action.

In an alternative preferred embodiment, after the step shown in FIG. 3b, the multilayer structure 300 is flipped and the other side is immersed, or at least partially immersed, into solution 400, which is contained in container 350 (FIG. 3e). At least one open channel situated along an edge, which in a preferred embodiment is different from the first edge, of multilayered structure 300 provides path(s) by which solution 400 permeates multilayered structure 300 substantially due to capillary action.

Multilayered structure 300 is removed from the portion of solution 400 that remains in container 350 and then, in a preferred embodiment, laid flat, as shown in FIG. 3(f). Cover plate 330 is removed from multilayered structure 300, leaving behind—as shown in FIG. 3(g)—substrate layer 310 coated with patterned spacer/pattern layer 320, the portion of solution 400 that has permeated, and coating material film 200′. With reference to FIG. 3(h), the permeating solution 400 dries into a coating material film 400′.

It should be noted that the processes described above may be repeated, not only to create a plurality of coating materials lying on the same plane, but also to build one layer on top of another. In an example of this alternative preferred embodiment, if, in FIG. 3(e), after coating material film 200′ is substantially dry (a process that may be assisted by baking, vacuum drying etc.), multilayered structure 300 is dipped in solution 400 from the opposite end than what is shown (i.e. the end of multilayered structure 300 that has coating material film 200′ is dipped into solution 400), then coating material film 400′ would lie substantially on top of coating material film 200′ in FIG. 3(h), instead of on the other end of substrate layer 310. In a preferred embodiment, spacer/pattern layer 320 provides an approximately 5-200 micron gap for solutions to enter, and once solution 200 dries, coating material 200′ is only approximately 50-200 nm thick, leaving plenty of room for more coating materials, thereby allowing a stack of two or more coating materials to be applied.

Example Application

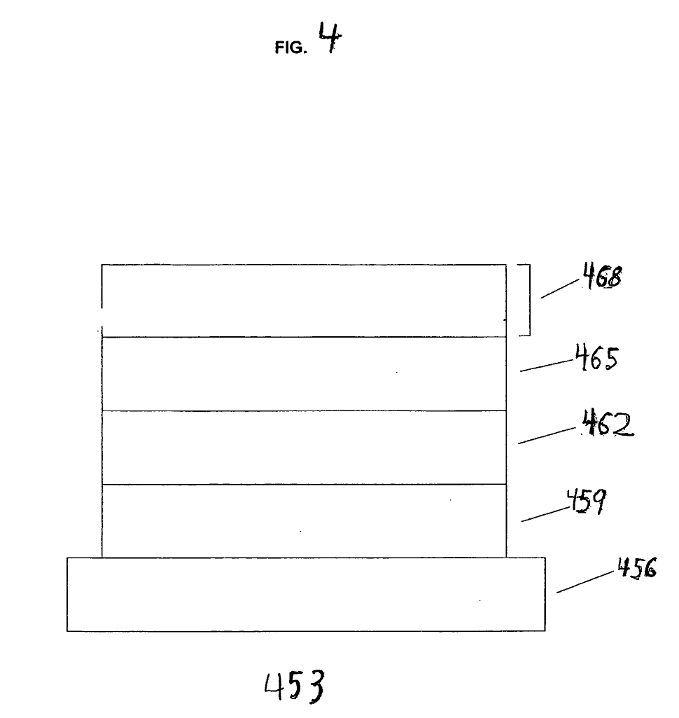

A specific example of an electronic device is an OLED. FIG. 4 shows an embodiment of an OLED 453 according to the present invention. The OLED 453 includes a substrate 456 that may be comprised of, for example, glass or plastic. The OLED 453 also includes a first electrode such as an anode layer 459 that is deposited on the substrate 456. The anode layer 459 may be, for example, indium tin oxide (“ITO”). The OLED 453 also includes at least one semiconductor layer, preferably, two organic layers: a conducting polymer layer 462 that is deposited on the anode layer 459, and an emissive polymer layer 465 that is deposited on the conducting polymer layer 462. The conducting polymer layer 462 assists in injecting and transporting holes. The emissive polymer layer 465 assists in injecting and transporting electrons. In one configuration of this embodiment, the emissive polymer layer 465 emits light. In another configuration, another separate layer is deposited that emits light. The OLED 453 includes a second electrode that is a cathode layer 468 that is deposited on the emissive polymer layer 465.

Alternatively, in another embodiment of the OLED, the cathode layer, rather than the anode layer, is deposited on the substrate. The emissive polymer layer is deposited on the cathode layer and the conducting polymer layer is deposited on the emissive polymer layer. The anode layer is deposited on the conducting polymer layer.

The present invention may be used, for example, to deposit conducting polymer layer 462 on the anode layer 459, and also to deposit emissive polymer layer 465 on conducting polymer layer 462. In a preferred embodiment, emissive polymer layer 465 is formed by applying solution to a substantially dried conducting polymer layer 462 in accordance with the process described above. These layers are discussed in greater detail below.

Anode Layer 459:

The anode layer 459 is a conductive substrate layer which serves as a hole-injecting layer and which comprises a material with work function greater than about 4.5 eV. Typical anode materials include metals (such as aluminum, silver, platinum, gold, palladium, tungsten, indium, copper, iron, nickel, zinc, lead, and the like); metal oxides (such as lead oxide, tin oxide, ITO, and the like); graphite; doped inorganic semiconductors (such as silicon, germanium, gallium arsenide, and the like); and doped conducting polymers (such as polyaniline, polypyrrole, polythiophene, and the like). When metals such as those listed above are used, the anode layer 459 is typically sufficiently thin so as to be semi-transparent to the light emitted from the emissive layer. Metal oxides such as ITO and conducting polymers such as polyaniline and polypyrrole are typically semi-transparent in the visible portion of the spectrum. Typically, the anode layer 459 has a thickness of about 300 Å to about 3000 Å.

Conducting Polymer Layer 462:

The conducting polymer layer 462 is used to enhance the hole yield of the OLED in relation to the electric potential applied. Preferred conductive polymers include, but are not limited to polyethylenedioxythiophene (“PEDOT”) and polyaniline (“PANI”).

Preferably, the thickness of the conducting polymer layer 462 is from about 5 to about 1000 nm, more preferably from about 50 to about 500 nm, and most preferably from about 50 to about 250 nm. The conducting polymer layer 462 is applied in the form of a solution using the techniques described above in accordance with the present invention.

Emissive Polymer Layer 465:

For OLEDs, the emissive polymer layer 465 comprises an electroluminescent, semiconductor, organic material. Examples of the emissive polymer layer 465 include:
(i) poly(p-phenylene vinylene) and its derivatives substituted at various positions on the phenylene moiety;
(ii) poly(p-phenylene vinylene) and its derivatives substituted at various positions on the vinylene moiety;
(iii) poly(p-phenylene vinylene) and its derivatives substituted at various positions on the phenylene moiety and also substituted at various positions on the vinylene moiety;
(iv) poly(arylene vinylene), where the arylene may be such moieties as naphthalene, anthracene, furylene, thienylene, oxadiazole, and the like;
(v) derivatives of poly(arylene vinylene), where the arylene may be as in (iv) above, and additionally have substituents at various positions on the arylene;
(vi) derivatives of poly(arylene vinylene), where the arylene may be as in (iv) above, and additionally have substituents at various positions on the vinylene;
(vii) derivatives of poly(arylene vinylene), where the arylene may be as in (iv) above, and additionally have substituents at various positions on the arylene and substituents at various positions on the vinylene;
(viii) co-polymers of arylene vinylene oligomers, such as those in (iv), (v), (vi), and (vii) with non-conjugated oligomers; and
(ix) polyp-phenylene and its derivatives substituted at various positions on the phenylene moiety, including ladder polymer derivatives such as poly(9,9-dialkyl fluorene) and the like;
(x) poly(arylenes) where the arylene may be such moieties as naphthalene, anthracene, furylene, thienylene, oxadiazole, and the like; and their derivatives substituted at various positions on the arylene moiety;
(xi) co-polymers of oligoarylenes such as those in (x) with non-conjugated oligomers;
(xii) polyquinoline and its derivatives;
(xiii) co-polymers of polyquinoline with p-phenylene substituted on the phenylene with, for example, alkyl or alkoxy groups to provide solubility; and
(xiv) rigid rod polymers such as poly(p-phenylene-2,6-benzobisthiazole), poly(p-phenylene-2,6-benzobisoxazole), polyp-phenylene-2,6-benzimidazole), and their derivatives.

A preferred polymeric emitting material that emits yellow-light and includes polyphenelenevinylene derivatives is available as SY132 from Covion Organic Semiconductors GmbH, Industrial park Hoechst, Frankfurt, Germany. Other especially preferred polymeric emitting material that emit red, green and blue light and include fluorene-copolymers that are available as Lumation series polymers from Dow Chemical, Midland, Mich.

Preferably, the thickness of emissive polymer layer 465 is from about 5 to about 1000 nm, more preferably from about 50 to about 500 nm, and most preferably from about 50 to about 250 nm. Emissive polymer layer 465 is applied in the form of a solution using the techniques described above in accordance with the present invention. Furthermore, as described above with respect to FIG. 3, it is possible to use different solutions to create different coating material lying in the same plane. Thus, emissive polymer layer may be multi-colored. In a preferred embodiment, during the manufacturing process of emissive polymer layer 465, the partially manufactured OLED 453 is dipped (from three different sides of the structure) in three different solutions to create three different colors. In alternative preferred embodiments, more or fewer colors are created by dipping more or fewer times in different solutions.

Cathode Layer 468:

The cathode 468 is a conductive layer which serves as an electron-injecting layer and which comprises a material with a low work function. While cathode 468 can be comprised of many different materials, preferable materials include aluminum, silver, magnesium, calcium, barium, or combinations thereof. More preferably, the cathode 468 is comprised of aluminum, aluminum alloys, or combinations of magnesium and silver. There can also be a thin (e.g. <50 nm, preferably <5 nm) insulating layer between the cathode and the emissive polymer layer to enhance electron injection by tunneling. The insulating layer can be made of, for example, lithium fluoride (“LiF”), sodium fluoride (“NaF”), or cesium fluoride (“CsF”).

Cathode 468 can be opaque, transparent, or semi-transparent to the wavelength of light generated within the device. The thickness of the cathode 468 may be from about 10 nm to about 1000 nm, preferably from about 50 nm to about 500 nm, and more preferably, from about 100 nm to about 300 nm.

The cathode 468 can typically be fabricated using any of the techniques known in the art for deposition of thin films, including, for example, vacuum evaporation, sputtering, electron beam deposition, or chemical vapor deposition.

While the invention has been described in terms of preferred embodiments, those skilled in the art will recognize that the invention can be practiced with modification within the spirit and scope of the appended claims.

1. A method of depositing material on a substrate layer, comprising the steps of:
(a) forming a multilayered structure, said forming comprising:
(i) coating said substrate layer with a spacer/pattern layer,
(ii) pressing a cover layer against said spacer/pattern layer;
(b) dipping said multilayered structure into solution containing said material for a sufficient length of time to allow said solution to spread through capillary action to a predetermined region defined by said spacer/pattern layer; and
(c) removing said cover layer from said spacer/pattern layer.

2. The method of depositing material on a substrate layer of claim 1, wherein said coating comprises:
placing said spacer/pattern layer on said substrate layer; and
selectively removing portions of said spacer/pattern layer to define said predetermined region.

3. An OLED (organic light emitting diode), wherein at least part of said OLED is manufactured using the method of depositing material on a substrate layer of claim 1.

4. A method of depositing a plurality of materials on a substrate layer, comprising the steps of claim 1 and further comprising the step of repeating step (b) with a different solution containing a different material until a stack of layers is formed, before said removing said cover layer.

5. An OLED, wherein at least part of said OLED is manufactured using the method of depositing a plurality of materials on a substrate layer of claim 4.

6. A method of depositing a plurality of materials on a substrate layer, comprising the steps of claim 1 and further comprising, after step (c), repeating steps a(ii), (b), and (c) with a different solution containing a different material until a stack of layers is formed.

7. An OLED, wherein at least part of said OLED is manufactured using the method of depositing a plurality of materials on a substrate layer of claim 6.

8. A method of depositing a first material and a second material on a substrate layer, comprising the steps of:
(a) forming a first multilayered structure, said forming comprising:
(i) coating said substrate layer with a spacer/pattern layer, wherein said spacer/pattern layer defines a first region and a separate second region,
(ii) pressing a first cover layer against said spacer/pattern layer;
(b) dipping said first multilayered structure into a first solution containing said first material for a sufficient length of time to allow said first solution to spread through capillary action to said first region;
(c) removing said cover layer from said spacer/pattern layer;
(d) pressing a second cover layer against said spacer/pattern layer to form a second multilayered structure;
(e) dipping said second multilayered structure into a second solution containing said second material for a sufficient length of time to allow said second solution to spread through capillary action to said second region; and
(f) removing said second cover layer from said spacer/pattern layer.

9. The method of depositing a first material and a second material on a substrate layer of claim 8, wherein said coating comprises:
placing said spacer/pattern layer on said substrate; and
selectively removing portions of said spacer/pattern layer to define said first region and said separate second region.

10. The method of depositing a first material and a second material on a substrate layer of claim 8, wherein said second cover layer is said first cover layer and said second multilayered structure is said first multilayered structure.

11. An OLED, wherein at least part of said OLED is manufactured using the method of depositing a first material and a second material on a substrate layer of claim 8.

12. A method of depositing at least three materials on a substrate layer, comprising the steps of claim 8, and further comprising the steps of:
(g) pressing a third cover layer against said spacer/pattern layer to form a third multilayered structure;
(h) dipping said third multilayered structure into a third solution containing said third material for a sufficient length of time to allow said third solution to spread through capillary action to said third region; and
(i) removing said third cover layer from said spacer/pattern layer.

13. A multilayered structure for depositing material on a substrate layer, comprising:
(a) said substrate layer;
(b) a spacer/pattern layer coating said substrate layer, wherein said spacer/pattern layer defines at least one region having at least one conduit for drawing in solution containing said material by way of capillary action; and
(c) a cover layer pressed against said spacer/pattern layer.

14. The multilayered structure for depositing material on a substrate layer of claim 13, wherein said at least one region is a plurality of regions, each one of said plurality of regions having a separate said at least one conduit.

15. An OLED comprising the multilayered structure for depositing material on a substrate layer of claim 13.

16. The multilayered structure for depositing material on a substrate layer of claim 14, wherein each of said plurality of regions has a different pattern, wherein at least one of said plurality of regions has a pattern comprising lines.

17. The multilayered structure for depositing material on a substrate layer of claim 14, wherein each of said plurality of regions has a different pattern, wherein at least one of said plurality of regions has a pattern comprising icons.

18. A method of depositing material on a substrate layer, comprising the steps of:
(a) forming a multilayered structure, said forming comprising:
(i) coating said substrate layer with a first part of a spacer/pattern layer,
(ii) pressing a cover layer attached to a remaining part of said spacer/pattern layer against said first part of said spacer/pattern layer to form a complete said spacer/pattern layer;
(b) dipping said multilayered structure into solution containing said material for a sufficient length of time to allow said solution to spread through capillary action to a predetermined region defined by said spacer/pattern layer; and
(c) removing said cover layer from said first part of a spacer/pattern layer.
